(19) United States
(12) Patent Application Publication
(10) Pub. No.: US 2017/0258273 A1
(43) Pub. Date: Sep. 14, 2017

(54) AUTOMATIC PROCESSING OF A FOOD PRODUCT

(71) Applicant: Vorwerk & Co. Interholding GmbH, Wuppertal (DE)

(72) Inventors: Christiane STACH, Radevormwald (DE); Markus CORNELISSEN, Bornheim (DE); Klaus-Martin WEBER, Wuppertal (DE); Stefan HILGERS, Essen (DE); Julius GANNS, Wuppertal (DE)

(73) Assignee: Vorwerk & Co. Interholding GmbH, Wuppertal (DE)

(21) Appl. No.: 15/506,305

(22) PCT Filed: Aug. 25, 2015
(86) PCT No.: PCT/EP2015/069436

§ 371 Date: Feb. 24, 2017

(30) Foreign Application Priority Data
Aug. 26, 2014 (DE) 10 2014 112 251.8

(51) Int. Cl. A47J 43/07; A47J 36/32

(52) U.S. Cl. CPC A47J 43/0716; A47J 36/32

(57) ABSTRACT

A method for automated processing of at least one food product according to at least one predetermined recipe parameter uses an electric kitchen appliance for producing a meal. The steps are as follows: detecting an actual parameter of the food product to be processed, comparing the actual parameter of the food product to be processed with a target parameter of the food product to be processed, and correcting the recipe parameter depending on the deviation of the actual parameter of the food product to be processed from the target parameter of the food product to be processed.

The invention relates to a method for automatically processing at least one food product according to at least one predetermined recipe parameter by means of an electrical kitchen appliance for producing a meal.

For example, electrical kitchen appliances for automatically processing a food product according to predetermined recipe parameters for producing a meal, e.g., in the form of universal food processors, are well known in practice. Apart from mechanically processing food products, e.g., by means of an agitator and/or cutting blade, such electrical kitchen appliances frequently also make it possible to cook the food products.

In order to produce various meals, predetermined recipes are here provided, typically in the form of recipe data stored in a memory connected with the kitchen appliance. These recipe data generally encompass recipe parameters, e.g., which indicate how long the food product to be processed has to be mixed in a predetermined mixing stage, or at what temperature the food product is to be cooked.

Suppliers of such electrical kitchen appliances along with recipes provided for the latter, which consist of corresponding recipe data, generally try to offer such cooking recipes that have a high probability of success. Even so, various compositions of the food product to be processed as well as specific environmental parameters, such as an especially high atmospheric humidity or a high ambient temperature, can have an influence on recipe implementation, namely in a way that no longer ensures that the recipe will succeed.

Users of such electrical kitchen appliances, which operate with predetermined recipes, could previously only counter this problem by relying upon their own experience and themselves actively deviate from the recipe parameters. For example, the quantity of ingredients, temperatures or even processing times can be varied so as to still arrive at satisfactory results even under conditions for the food products to be processed or environmental conditions lying outside of the standard range. However, this is difficult for inexperienced users, resulting in the danger that the recipes will not go well in such cases.

Proceeding from this problem, the object of the invention is to indicate a method for automatically processing a food product by means of an electrical kitchen appliance with a high probability of success.

This object is achieved by the subject matter of claim 1. Preferred further developments of the invention are described in the subclaims.

Therefore, the invention provides a method for automatically processing at least one food product according to at least one predetermined recipe parameter by means of an electrical kitchen appliance for producing a meal, with the following steps:

Detecting an actual parameter for the food product to be processed,

Comparing the actual parameter for the food product to be processed with a target parameter for the food product to be processed, and

Correcting the recipe parameter depending on the deviation of the actual parameter for the food product to be processed from the target parameter for the food product to be processed.

As a consequence, one essential aspect of the invention involves detecting an actual parameter for the food product that is currently actually being processed. This actual parameter is compared with a target parameter, which indicates how the food product is to really be at the defined point in time while being processed with the predetermined recipe parameter. If it turns out that the actual parameter and target parameter deviate from each other over a predetermined tolerance range, the recipe parameter is corrected as a function of this deviation, so as to bring the actual parameter closer to the target parameter as the food product continues to be processed.

The actual parameter can here be detected in predetermined time intervals, so as to compare the actual parameter with the target parameter in these time intervals, and then correct the recipe parameter as needed. At predetermined times in the automatic processing, respective target parameters of the food product to be processed are to this end stored, and used for making an adjustment by means of the respective currently detected actual parameter. This repeated detection of the actual parameter and ensuing comparison with the respective target parameter for determining a potentially necessary correction of the recipe parameter already enables the achievement of good results during production of the meal, which can significantly improve the probability of success.

However, a preferred further development of the invention provides that the steps of detecting the actual parameter for the food product to be processed, comparing the actual parameter for the food product to be processed with the target parameter for the food product to be processed, and correcting the recipe parameter depending on the deviation of the actual parameter for the food product to be processed from the target parameter for the food product to be processed take place regularly, i.e., always in the same time intervals, very especially preferably continuously or quasi-continuously.

In other words, this means that the actual parameter for the food product to be processed in this preferred further development of the invention is repeatedly and regularly detected over and over in predetermined time intervals. However, it is further preferred that the actual parameter be detected roughly progressively (quasi-continuously), i.e., repeatedly in very short time intervals, or progressively (continuously), so that the recipe parameter can be corrected at virtually any time through comparison with the target parameter. This approach is advantageous in that only relatively slight corrections of the recipe parameter are thus generally required, since continuously or quasi-continuously updating the recipe parameter so as to keep the deviation of the actual parameter from the target parameter low permits no large deviations as a whole.

The actual parameter and target parameter can consist of a plurality of the parameters for the food product to be processed. Especially preferred are those parameters that have an effect on the taste, appearance and/or consistency of the meal to be produced. Actual and target parameters very especially preferably encompass at least one of the following parameters of the food product to be processed at a predetermined point in time during the automatic processing of the food product: Temperature of the food product to be processed, color of the food product to be processed, consistency of the food product to be processed and hardness of the food product to be processed.

There are also a plurality of options for the recipe parameter to be corrected. It is preferably provided that the recipe parameter encompass at least one of the following parameters for the electrical kitchen appliance:

Cooking time, heating curve, mixing time, mixing speed, cutting time, cutting speed, kneading time and kneading speed.

A preferred further development of the invention further provides that the method additionally encompass the following step:

Correcting the recipe parameter by outputting a prompt to a user of the electrical kitchen appliance to add a defined quantity of at least one defined food product.

In those cases in which there is no longer a prospect that the recipe can be made to succeed with the food product located in the electrical kitchen appliance, this further development of the invention makes it possible to still “save” the recipe by adding a predetermined quantity of another food product. When producing a dough, for example, this can mean that the user of the electrical kitchen appliance is prompted to add a predetermined quantity of water or flour, depending on whether the dough is too hard or soft.

A preferred further development of the invention also provides that the method additionally exhibit the following step:

Outputting a message to a user of the electrical kitchen appliance that automatically processing the food product can probably not lead to the desired success or can probably no longer lead to success at all.

Such an output to the user is preferably provided if the recipe can no longer be “saved” even by adding a defined quantity of at least one defined food product. In such a case, in which the user can thus no longer count on the desired meal being producible, the user in this preferred further development of the invention receives a corresponding warning.

A preferred further development of the invention provides that the electrical kitchen appliance automatically stop processing the food product in response to this warning. Alternatively, an inquiry is output to the user as to whether the food product should continue to be processed nonetheless, or whether a termination should ensue.

Otherwise, it is preferably provided that the recipe parameter together with the target parameter, preferably a plurality of recipe parameters with respective accompanying target parameters, be stored in a memory connected with the electrical kitchen appliance. Such a memory, which stores recipe parameters with respectively accompanying target parameters, can be an integral constituent of the electrical kitchen appliance. However, it is preferably provided that the memory be detachably connectable with the electrical kitchen appliance. To this end, a direct connection of the memory with the electrical kitchen appliance can be provided, e.g., in the form of a USB stick being connected with a computer. Alternatively or additionally, a preferred further development of the invention provides a connection of the electrical kitchen appliance with a remote memory, e.g., with a server from the supplier of the electrical kitchen appliance, which stores data that can be retrieved by the electrical kitchen appliance, e.g., via the internet.

A preferred further development of the invention also provides that one of the recipe parameters, preferably a plurality of recipe parameters, be indirectly selected by the user of the electrical kitchen appliance before automatically processing the food product by inputting a recipe designation for the meal to be produced into the electrical kitchen appliance. This means that, when a meal is selected by the user, such as “spaghetti al dente”, recipe parameters required for this purpose are indirectly selected, such as a predetermined cooking duration, e.g., 8 minutes, at a predetermined temperature, such as 95° C.

In this way, the user of the electrical kitchen appliance then does not have to directly indicate the recipe parameters, such as cooking duration or cooking temperature, which are necessary to arrive at his or her desired result. Rather, he or she only inputs or selects the desired end result (“spaghetti al dente”), and the electrical kitchen appliance for this purpose automatically receives the required recipe parameter from the memory, where the corresponding recipe parameters are stored. Reconciling the target parameters with the actual parameter for the food product to be processed as provided according to the invention ensures that the desired result (al dente) is actually achieved.

In this conjunction, it is especially preferred that the recipe designation for the meal encompass a parameter for the completely produced meals, preferably the quantity of meal to be produced and/or the consistency of the meal. Otherwise, it can advantageously also be input whether the recipe is to be implemented as quickly as possible, or rather carefully, which might involve a lower cooking temperature, and thus take longer, but can lead to a healthier result.

There are various options for inputting the recipe designation. For example, it can be provided that a recipe be selected from a recipe database, or that an alphanumeric input of the recipe name take place. However, a preferred further development of the invention provides that the electrical kitchen appliance provide a query dialog for entering a recipe designation. This means that, after making the basic selection of a meal, such as “spaghetti”, the user is asked at least one additional question by the electrical kitchen appliance, such as about consistency, in response to which he or she can then select “al dente”, for example.

The invention will be explained in greater detail below with reference to the drawing based on a preferred exemplary embodiment.

Schematically depicted in the drawing on the sole figure is an electrical kitchen appliance for implementing a method according to a preferred exemplary embodiment of the invention.

Before discussing two preferred exemplary examples of methods for automatically processing at least one food product according to a predetermined recipe parameter by means of an electrical kitchen appliance for producing a meal, such an electrical kitchen appliance suitable for implementing this method will first be described.

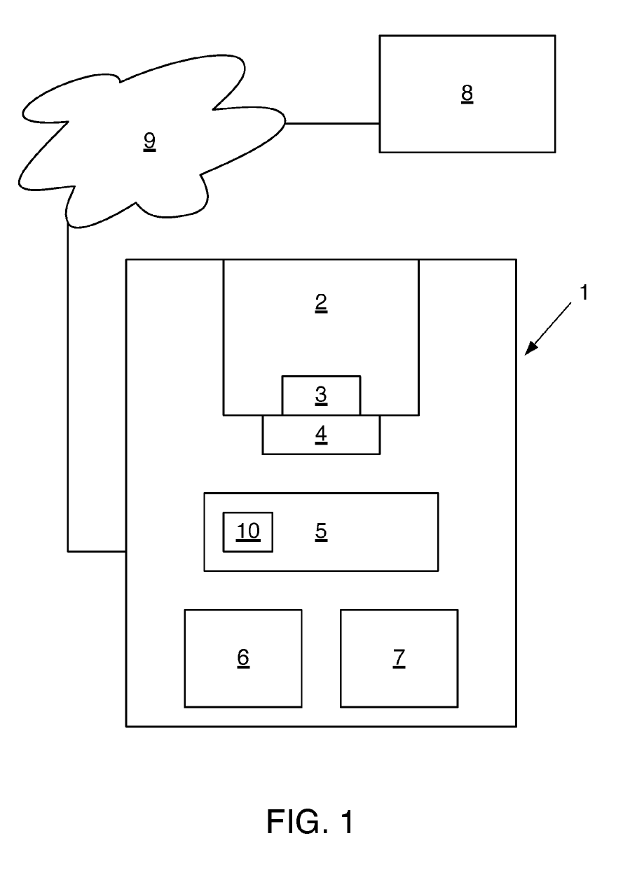

Such an electrical kitchen appliance 1 is visible on FIG. 1. The latter encompasses a processing chamber 2, which incorporates an agitating and cutting mechanism 3. This agitating and cutting mechanism 3 can be used to mix and knead food products to be processed in the processing chamber 2, e.g., to make a dough. In addition, the food product can be comminuted thanks to the cutting function of the agitating and cutting mechanism 3, e.g., for making raw vegetable salads, or also for making a soup by pureeing a food product. The agitating and cutting mechanism 3 is driven by means of a drive 4. In the presently described electrical kitchen appliance 1, the drive 4 involves an electric motor.

The functions of the electrical kitchen appliance 1 are controlled by a central control unit 5, which is provided with a memory 10. This memory 10 stores predetermined recipe parameters, which are used for automatically processing a food product provided in the processing chamber 2 for producing a meal. In addition, the memory 10 exhibits target parameters for the food products to be processed, each specifically stored for a corresponding recipe parameter, which, as described in detail further below, can be compared with respective currently detected actual data for the food product to be processed.

The electrical kitchen appliance 1, and hence in particular the memory 10 of the central control unit 5, is connected with a remote server 8 via the internet 9. In this way, data can be transmitted from the server 8 to the electrical kitchen appliance 1 over the internet 9, and then stored in the memory 10 of the central control unit 5. As a result, recipe data with recipe parameters and target parameters associated therewith can be brought to the electrical kitchen appliance 1, and these recipe data can be easily kept current or updated at any time.

The electrical kitchen appliance 1 further exhibits a display device 6, which displays recipes stored in the memory 10 to the user of the electrical kitchen appliance 1, along with an input device 7, with which the user can select the recipe he or she desires.

The process of making a yeast dough for a pizza is described in the method according to a first preferred exemplary embodiment of the invention described below. In a first step, the recipe “Pizza dough” is selected from the recipes stored in the memory 10. This takes place via the display device 6 or input device 7. After selecting the “Pizza dough” recipe, the user is asked in the next step to specify how many people the dough is being made for. After the user has thereupon input the number of people to be served by the pizza dough to be produced, the central control unit 5, based on recipe data stored in the memory 10 for the recipe “Pizza dough”, determines the required quantities of ingredients, such as water, wheat flour, salt, oil and yeast, which are shown to the user by the display device 6. These ingredients are to be filled into the processing chamber 2 of the electrical kitchen appliance 1 by the user in the specified quantities.

Also determined is a target parameter, which is to be reached after a kneading time of three minutes. This target parameter involves a parameter that describes the consistency of the dough. The consistency of the dough is indirectly established according to the presently described preferred exemplary embodiment of the invention by determining the resistance offered by the dough to the agitating and cutting mechanism 3 in the kneading process. This can be determined via the drive 4 for the agitating and cutting mechanism 3, so that the target parameter for the consistency of the pizza dough can be ascertained by way of an electrical measured value.

After the user starts automatic processing by making a corresponding input with the input device 7, the ingredients added in the processing chamber 7 are kneaded for three minutes until the actual parameter for the consistency of the dough is determined as discussed above by way of the resistance which the dough offers the agitating and cutting mechanism 3. This actual parameter is compared with the target parameter determined beforehand. If the two parameters coincide within a prescribed tolerance range, processing of the food product is ended; the dough is finished.

However, if the actual parameter and target parameter deviate from each other beyond the prescribed tolerance range, processing of the food product continues. Depending on whether the electrical value determined via the drive 4 for the agitating and cutting mechanism 3 makes it possible to infer a softer or harder consistency for the dough than provided, the user of the electrical kitchen appliance 1 in the presently described preferred exemplary embodiment of the invention is prompted by the display device 6 to add more water, so as to achieve a softer consistency, or more flour, if the consistency of the dough is not yet hard enough.

While the process of kneading the dough could have been ended upon expiration of the three minutes had the actual parameter coincided with the target parameter, the recipe parameter “kneading duration” must be changed if the actual parameter deviates from the target parameter beyond the tolerance range, specifically extended by one minute in the present preferred exemplary embodiment of the invention, so as to knead the added water or added flour into the already existing dough.

The actual parameter for the consistency of the dough is then determined again. If the latter corresponds to the target parameter, also within the prescribed tolerance range, dough preparation has ended; otherwise, the process described above is again followed: The user is prompted to add a prescribed quantity of water or flour, and kneading is extended for another minute.

This process is repeated until such time that the determined actual value for the consistency of the dough corresponds with the target value within the prescribed tolerance range. However, the processing chamber 2 naturally only has a predetermined maximum holding capacity, so that the process described above cannot be continued for as long as desired. Therefore, the presently described preferred exemplary embodiment of the invention provides that water or flour can be refilled only three times. If a satisfactory result has then still not been achieved, i.e., the actual parameter still deviates from the target parameter beyond the predetermined tolerance range, the display device 6 outputs a message to the user that the dough can no longer be expected to succeed, and the processing of the food product is automatically terminated.

The second preferred exemplary embodiment of the invention relates to making whipped cream. After selecting the recipe “Whipped cream” with the input device 7, the display device 6 in a further dialogue with the user of the electrical kitchen appliance 1 asks whether soft whipped cream or stiff whipped cream is desired. Depending on the parameter “soft” or “stiff”, a combination made up of the rotational speed of the agitating and cutting mechanism 3 and the duration of mixing with the agitating and cutting mechanism 3 is set as the recipe parameter. Corresponding default settings are derived from the recipe data, which are stored in the memory 10 of the central control unit 5.

As opposed to making pizza dough as described above, during which an actual parameter for the food product to be processed was detected for the first time only after three minutes, making whipped cream as described here involves detecting the consistency of the cream quasi-continuously, i.e., progressively in very short time intervals. To this end, an expected progression curve in terms of the firmness of the whipped cream is indicated in the memory 10 of the central control unit 5, which, as explained in the previously described exemplary embodiment, is determined based on the resistance that the food product processed in the processing chamber 2 offers to the agitating and cutting mechanism 3.

Beyond that, automatically processing the cream to make whipped cream also does not provide for introducing additional quantities of another food product if the cream appears not to be yielding success, i.e., in particular is not getting stiff. What is instead stored in the memory 10 of the central control unit 5 for this purpose is that the mixing speed be continuously increased and that mixing take place over a predetermined period of time, but only up to a maximum mixing duration, at less than the resistance value offered to the agitating and cutting mechanism 3.

If this maximum mixing duration is exceeded without having been able to detect the desired firmness of the whipped cream, the display device 6 indicates to the user of the electrical kitchen appliance 1 that the desired result, specifically the stiffly beaten whipped cream, can probably no longer be achieved. The user can then input via the input device 7 whether he or she still wishes to continue processing the cream anyway, of whether processing the cream is to be terminated.

### REFERENCE LIST

1 Electrical kitchen appliance
2 Processing chamber
3 Agitating and cutting mechanism
4 Drive for the agitating and cutting mechanism
5 Central control unit
6 Display device
7 Input device
8 Server
9 Internet
10 Memory

1. A method for automatically processing at least one food product according to at least one predetermined recipe parameter by means of an electrical kitchen appliance (1) for producing a meal, with the following steps:
Detecting an actual parameter for the food product to be processed,
Comparing the actual parameter for the food product to be processed with a target parameter for the food product to be processed, and correcting the recipe parameter depending on the deviation of the actual parameter for the food product to be processed from the target parameter for the food product to be processed, wherein the recipe parameter is corrected by outputting a prompt to a user of the electrical kitchen appliance (1) to add a defined quantity of at least one defined food product.

2. The method according to claim 1, wherein the steps of detecting the actual parameter for the food product to be processed, comparing the actual parameter for the food product to be processed with the target parameter for the food product to be processed, and correcting the recipe parameter depending on the deviation of the actual parameter for the food product to be processed from the target parameter for the food product to be processed take place repeatedly.

3. The method according to claim 1, wherein the actual and target parameters encompass at least one of the following parameters of the food product to be processed at a predetermined point in time during the automatic processing of the food product: Temperature of the food product to be processed, color of the food product to be processed, consistency of the food product to be processed and hardness of the food product to be processed.

4. The method according to claim 1, wherein the recipe parameter encompasses at least one of the following parameters of the electrical kitchen appliance: Cooking time, heating curve, mixing time, mixing speed, cutting time, cutting speed, kneading time and kneading speed.

5. (canceled)

6. The method according to claim 1, wherein the method additionally exhibits the following step:
Outputting a message to a user of the electrical kitchen appliance (1) that automatically processing the food product can probably not lead to the desired success or can probably no longer lead to success at all.

7. The method according to claim 1, wherein the recipe parameter together with the target parameter, preferably a plurality of recipe parameters with respective accompanying target parameters, are stored in a memory (10) connected with the electrical kitchen appliance (1).

8. The method according to claim 1, wherein one of the recipe parameters, preferably a plurality of recipe parameters, is offered for selection to the user of the electrical kitchen appliance (1) before automatically processing the food product indirectly by inputting a recipe designation for the meal to be produced into the electrical kitchen appliance (1).

9. The method according to claim 8, wherein the recipe designation for the meal encompasses a parameter for the completely produced meals, preferably the quantity of meal to be produced and/or the consistency of the meal.

10. The method according to claim 1, wherein the electrical kitchen appliance (1) provides a query dialog to the user for entering a recipe designation.
